(19) United States
(12) Patent Application Publication
(10) Pub. No.: US 2026/0278997 A1
(43) Pub. Date: Sep. 17, 2026

(54) ULTRASOUND IMAGE PROCESSING APPARATUS

(71) Applicant: FUJIFILM Corporation, Tokyo (JP)

(72) Inventors: Misaki MARUYAMA, Tokyo (JP); Nobuhiko FUJII, Tokyo (JP); Ryota HASEGAWA, Tokyo (JP)

(73) Assignee: FUJIFILM Corporation, Tokyo (JP)

(21) Appl. No.: 19/467,743

(22) Filed: Feb. 2, 2026

(30) Foreign Application Priority Data
Feb. 14, 2025 (JP) 2025-022391

(51) Int. Cl. G06V 10/28; G06V 10/26; G06V 10/764; G06V 10/82

(52) U.S. Cl. CPC G06V 10/28; G06V 10/267; G06V 10/764; G06V 10/82; G06V 2201/031

(57) ABSTRACT

An ultrasound image processing apparatus includes a processor configured to calculate a brightness histogram of a B-mode tomographic image and to calculate a set of a plurality (for example, two) of Gaussian functions that approximate the brightness histogram (multi-distribution function analysis). The processor is configured to determine a threshold value that divides classes based on the Gaussian function selected from among the plurality of Gaussian functions based on a predetermined condition (classification threshold value calculation). The processor is configured to divide the B-mode tomographic image into a plurality of segments and classify each segment into a plurality of classes based on the threshold value (class classification).

### CROSS REFERENCE TO RELATED APPLICATION

This application claims priority to Japanese Patent Application No. 2025-022391 filed on Feb. 14, 2025, which is incorporated herein by reference in its entirety including the specification, claims, drawings, and abstract.

### BACKGROUND OF THE DISCLOSURE

### 1. Field of the Disclosure

The present disclosure relates to an ultrasound image processing apparatus, and particularly to brightness correction.

### 2. Description of the Related Art

Among types of processing performed by the ultrasound diagnostic apparatus, there is processing called brightness correction or gain correction (hereinafter, collectively referred to as brightness correction) for appropriately correcting brightness and contrast of an ultrasound image.

For example, in a case where a brightness of a deep part is low due to attenuation of the ultrasound and observation is difficult, it is desired to increase the brightness of the deep part. On the contrary, in a case where a signal is weak and noise is conspicuous even in a case where the brightness is increased, it is desired to decrease the brightness. In addition, in a case where a structure having a high signal intensity is saturated at high brightness, it is desired to decrease the brightness. The brightness correction is performed in accordance with such a purpose.

The brightness correction is performed by a manual operation of a user or automatically performed by the apparatus. In the brightness correction by the manual operation, generally, there is a method of uniformly adjusting a brightness of the entire screen and a method of adjusting brightness for each depth. The adjustment for each depth is called time gain control (TGC) or sensitivity time control (STC).

An automatic brightness correction function is not limited to reducing the burden on the user, and is used to realize two-dimensional correction that is difficult to set by the manual operation of the user.

In addition, the following technology is known as a technology of automatically executing the brightness correction of the ultrasound image.

The ultrasound diagnostic apparatus disclosed in JP2010-068987A generates an equalization offset pattern for equalizing a brightness level of a tomographic image frame. In the generation processing, the tomographic image frame is divided into a plurality of sub-areas, an average brightness of the sub-area is calculated, and a brightness difference between the average brightness of the sub-area and a reference brightness that is an average brightness of the entire tomographic image frame is calculated. An adjustment value is determined based on a brightness value histogram of the sub-area and a brightness value histogram of the entire tomographic image frame, and an offset value of the sub-area is determined by multiplying the brightness difference by the adjustment value. Then, the equalization offset pattern including an offset value corresponding to all pixels of the tomographic image frame is calculated based on the offset value of the sub-area. A gain for each of pixels is determined using the equalization offset pattern generated in this way. According to this method, the sub-area can be divided into a low brightness region, an intermediate brightness region, and a high brightness region, and only a gain level of the intermediate brightness region can be focused on equalization.

The ultrasound diagnostic apparatus disclosed in JP2007-117167A and JP2007-117168A divides a B-mode tomographic image into a plurality of regions, obtains a peak brightness from a brightness histogram for each region, and calculates a brightness difference between the obtained peak brightness and a brightness target value determined for each region. Then, a brightness difference representative value is obtained by weighting and adding the brightness difference of each region using a weight assigned to each region, and the gain is automatically and repeatedly adjusted until the brightness difference representative value is sufficiently close to the target value.

In a method of performing correction for each brightness range such as low brightness, intermediate brightness, and high brightness, it is important to appropriately set a threshold value that divides the brightness range. However, a related art that proposes a method of appropriately setting the threshold value is not known.

### SUMMARY OF THE DISCLOSURE

There is provided an ultrasound image processing apparatus according to the present disclosure comprising: a processor, in which the processor is configured to approximate a brightness histogram of a correction target ultrasound image using a combination of a plurality of distribution functions, determine one or more threshold values for a brightness based on at least one of the plurality of distribution functions, divide the correction target ultrasound image into a plurality of regions, classify the plurality of regions into a plurality of classes based on the one or more threshold values, and execute, for each of the plurality of regions, brightness correction for each of pixels in the region in accordance with a target brightness corresponding to the class to which the region belongs.

Here, the processor may be configured to select one distribution function from among the plurality of distribution functions, and determine the one or more threshold values based on the selected distribution function.

Further, the plurality of distribution functions may be two distribution functions, and the processor may be configured to select, in the selection, a distribution function on a low-brightness side of the two distribution functions, in a case where a height at a peak of the distribution function on the low-brightness side of the two distribution functions is equal to or higher than a predetermined number of times a height at a peak of a distribution function on a high-brightness side of the two distribution functions and a brightness corresponding to the peak of the distribution function on the low-brightness side is equal to or more than a predetermined value.

In addition, the processor may be configured to correct, as the brightness correction, a brightness for each of the pixels such that an average brightness is equal among regions belonging to the same class.

In addition, intervals each having a predetermined magnitude or greater may be provided between the respective target brightnesses of adjacent classes.

In addition, the processor may be configured to execute pre-correction on an ultrasound image before the correction and handle the ultrasound image subjected to the pre-correction as the correction target ultrasound image. In this case the pre-correction may include lateral pre-correction of increasing the brightness as a position is closer to an end part in a lateral direction for the ultrasound image before the correction.

In addition, the pre-correction may further include depth direction pre-correction of increasing the brightness as a depth increases in a depth direction for the ultrasound image before the correction, and an upper limit value of an amount of increase in the brightness due to the lateral pre-correction may be larger than an upper limit value of an amount of increase in the brightness due to the depth direction pre-correction.

In addition, the processor may be configured to determine, based on a recognition result of a cross section represented by the ultrasound image, at least one of a type of a distribution function used as the plurality of distribution functions or the number of distribution functions constituting the combination of the plurality of distribution functions.

In addition, the processor may be configured to determine a calculation condition of the one or more threshold values based on a recognition result of a cross section represented by the ultrasound image, and determine the one or more threshold values according to the calculation condition.

### BRIEF DESCRIPTION OF THE DRAWINGS

FIG. 1 is a diagram showing an example of a hardware configuration of a computer that executes processing of an embodiment.

FIG. 2 is a diagram showing an outline of a flow of processing of the embodiment.

FIG. 3 is a diagram showing a detailed flow of class classification processing.

FIG. 4 is a diagram showing an example of approximating a brightness histogram of a B-mode tomographic image with a set of two Gaussian functions.

FIG. 5 is a diagram for describing case division in a case of selecting a Gaussian function to be used as a reference in a case where a lower limit value and an upper limit value of an intermediate brightness are determined.

FIG. 6 is a diagram for describing a transition of data until a class classification result for each segment is obtained from a B-mode tomographic image.

FIG. 7 is a diagram showing a detailed flow of brightness correction processing.

FIG. 8 is a diagram showing another example of the detailed flow of the brightness correction processing.

FIG. 9 is a diagram showing an outline of a flow of processing of a modification example including pre-correction processing.

FIG. 10 is a diagram showing an arrangement of segments in a lateral direction and a depth direction.

FIG. 11 is a diagram showing an outline of the flow of processing of the modification example including the pre-correction processing.

FIG. 12 is a diagram showing a brightness histogram of a B-mode tomographic image of a liver and a heart and a set of Gaussian functions that approximate the brightness histogram.

### DESCRIPTION OF THE PREFERRED EMBODIMENTS

Hereinafter, embodiments of the present disclosure will be described with reference to the drawings. An ultrasound image processing apparatus in the present embodiment generates an ultrasound image displayed by an ultrasound diagnostic apparatus. The generated ultrasound image is, for example, a B-mode tomographic image.

Processing for image generation executed by the ultrasound image processing apparatus of the present embodiment is executed by, for example, a computer. In one example, the computer is built into the ultrasound diagnostic apparatus. In this example, the ultrasound image processing apparatus of the present embodiment is the ultrasound diagnostic apparatus itself or an image processing system into which the ultrasound diagnostic apparatus is built.

In addition, in another example, the processing for the image generation in the present embodiment may be executed by an external computer outside the ultrasound diagnostic apparatus. In this example, the external computer is connected to the ultrasound diagnostic apparatus via a communication path such as a data communication network. The external computer in this example may be a single computer, or may be made up of a plurality of computers that cooperate with each other through communication via a data communication network to implement the processing.

In addition, in another example, the processing may be executed by cooperation between the computer built into the ultrasound diagnostic apparatus and the external computer connected to the ultrasound diagnostic apparatus.

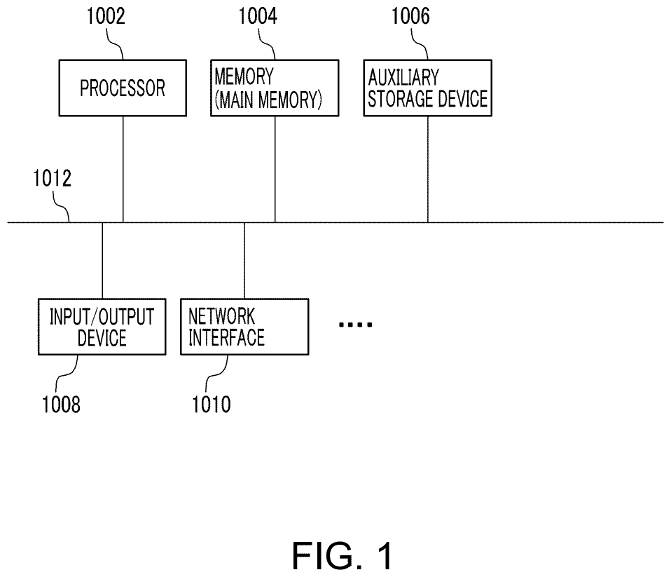

FIG. 1 shows an example of a hardware configuration of a computer built into the ultrasound diagnostic apparatus or connected to the ultrasound diagnostic apparatus. The computer shown in the figure has a circuit configuration in which a processor 1002, a memory (main storage device) 1004 such as a random-access memory (RAM), a controller that controls an auxiliary storage device 1006 which is a non-volatile storage device such as a flash memory, a solid-state drive (SSD), or a hard disk drive (HDD), an interface with various input/output devices 1008, a network interface 1010 that performs control for connection to a network such as a local area network, and the like are connected via a data transmission path such as a bus 1012. For example, a program describing the processing of the present embodiment is installed on the computer and is stored in the auxiliary storage device 1006. The program stored in the auxiliary storage device 1006 is executed by the processor 1002 using the memory 1004, thereby implementing the ultrasound image processing apparatus in the present embodiment.

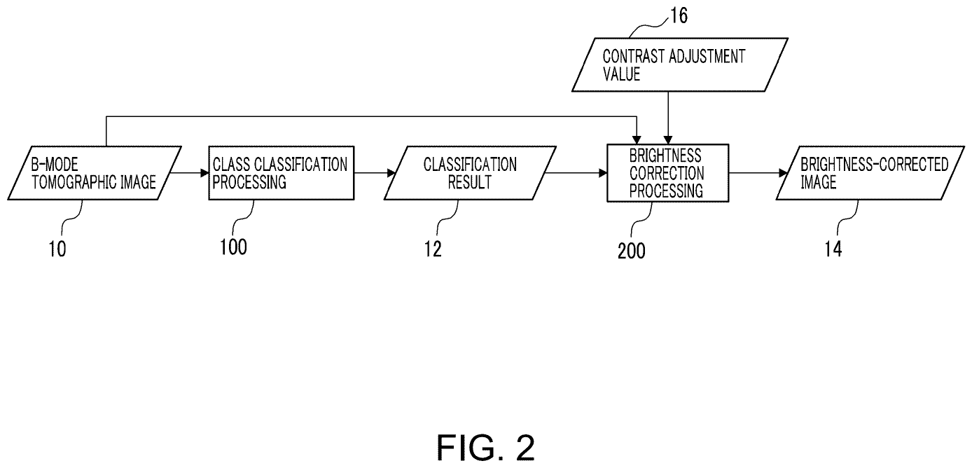

FIG. 2 shows an example of a flow of processing executed by the processor 1002 of the ultrasound image processing apparatus according to the present embodiment on the ultrasound image. Hereinafter, an example of processing a B-mode tomographic image 10 as an example of the ultrasound image will be described.

In this processing, the processor 1002 first performs class classification processing 100 on the B-mode tomographic image 10 input from the ultrasound diagnostic apparatus or the like. The class classification processing 100 classifies each of pixels of the B-mode tomographic image 10 into a plurality of classes having different brightnesses. For example, the classification is performed into three classes of low brightness, intermediate brightness, and high brightness. A classification result 12 indicating the class of each of the pixels is generated by the class classification processing 100. A detailed procedure of the class classification processing 100 will be described later.

The processor 1002 performs brightness correction processing 200 on the B-mode tomographic image 10 with reference to the classification result 12. In the brightness correction processing 200, the brightness for each of the pixels of the B-mode tomographic image 10 is corrected in accordance with the class of the pixel. In the brightness correction processing 200, a contrast adjustment value 16 for each class is referred to. The contrast adjustment value 16 for each class is a brightness offset determined to provide sufficient contrast (in this case, a brightness difference) between adjacent classes. For example, in a case where it is desired to set the class “low brightness” to be at least about 10 and to provide a brightness difference of about 40 between the class “low brightness” and “intermediate brightness”, the contrast adjustment values of the class “low brightness” and “intermediate brightness” may be set to 10 and 50, respectively. The contrast adjustment value 16 for each class is determined in advance by a developer or a user of the system in consideration of a desired image quality.

A brightness-corrected image 14 is generated by the brightness correction processing 200. The brightness-corrected image 14 is displayed on, for example, a screen provided in the ultrasound diagnostic apparatus.

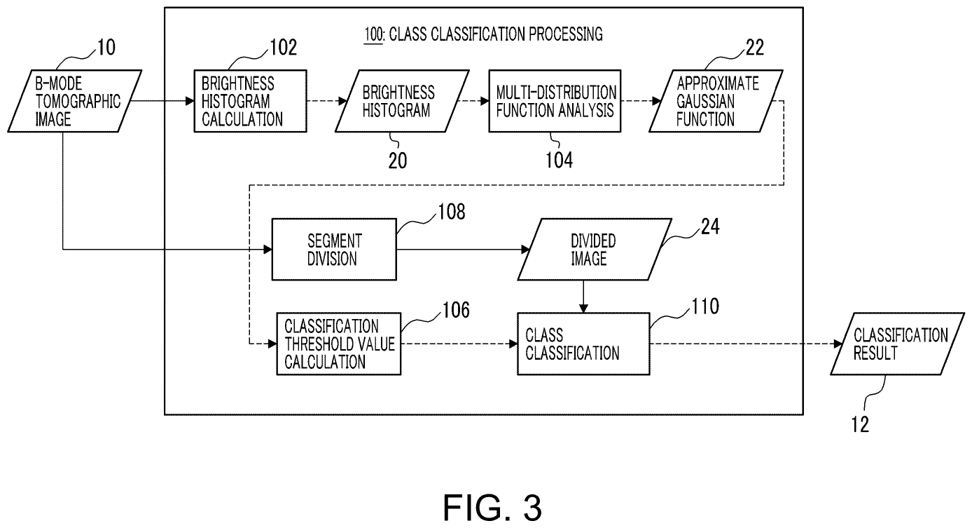

An example of the class classification processing 100 of the present embodiment will be described with reference to FIG. 3. The class classification processing 100 is configured by some types of sub-processing. Among the types of sub-processing, brightness histogram calculation 102, multi-distribution function analysis 104, classification threshold value calculation 106, segment division 108, and class classification 110 are included.

In the class classification processing 100, the processor 1002 first executes the brightness histogram calculation 102. In the brightness histogram calculation 102, a brightness histogram 20 of the input B-mode tomographic image 10 is obtained. The brightness histogram 20 is a graph representing the number of pixels having a brightness in the B-mode tomographic image 10 for each brightness.

The processor 1002 executes the multi-distribution function analysis 104 on the brightness histogram 20. The multi-distribution function analysis 104 is processing of obtaining a set of n (n is an integer of 2 or more) distribution functions that approximate the brightness histogram 20. In other words, the multi-distribution function analysis 104 is processing of fitting the brightness histogram 20 with a set of n distribution functions.

As the distribution function, various statistical distribution functions such as a Gaussian function and a Lorentz function can be used. The set of n distribution functions is typically a set consisting of n distribution functions of the same type, but may be a mixture of distribution functions of different types. For example, the processing of fitting the histogram with a set of a plurality of Gaussian functions is called multi-Gaussian fitting.

The processing of fitting the brightness histogram 20 with a plurality of distribution functions (for example, two Gaussian functions) can be performed by an algorithm known in the related art.

An approximate Gaussian function 22 is obtained by the multi-distribution function analysis 104. The approximate Gaussian function 22 is a set of a plurality of distribution functions that approximate the brightness histogram 20. Hereinafter, a case of approximating the brightness histogram 20 with a set of two Gaussian functions will be described as an example. In this example, the approximate Gaussian function 22 includes information for specifying the two Gaussian functions. The information for specifying the Gaussian function is a set of three values of a maximum value α, an average value μ, and a standard deviation σ of the Gaussian function.

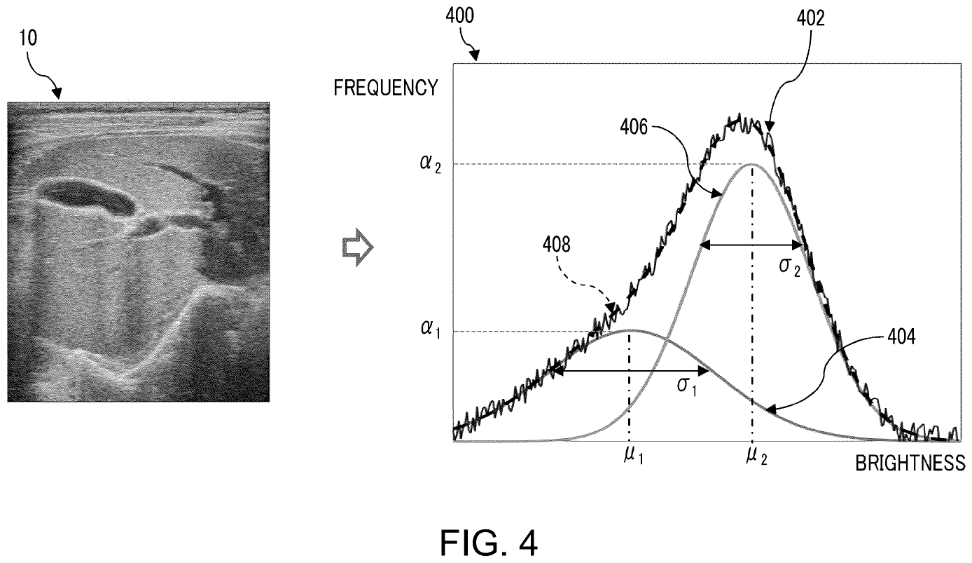

FIG. 4 shows the B-mode tomographic image 10 and an analysis result 400 for the B-mode tomographic image 10. The analysis result 400 shows a curve 402 indicating the brightness histogram 20 calculated from the B-mode tomographic image 10 by the brightness histogram calculation 102. A set of two Gaussian functions 404 and 406 that approximate the brightness histogram 20 is obtained by the multi-distribution function analysis 104. μ₁ and σ₁ are an average value and a standard deviation of the Gaussian function 404, respectively, and μ₂ and σ₂ are an average value and a standard deviation of the Gaussian function 406, respectively. By adding the Gaussian functions 404 and 406, a broken line curve 408 that approximates the brightness histogram 20 is obtained.

Returning to the description of FIG. 3, next, the processor 1002 executes the classification threshold value calculation 106. The classification threshold value calculation 106 is processing of calculating a threshold value that divides a brightness range from data of the approximate Gaussian function 22. For example, in a case where the brightness range is divided into three ranges of low brightness, intermediate brightness, and high brightness, the classification threshold value calculation 106 calculates a first threshold value that divides the low brightness and the intermediate brightness and a second threshold value that divides the intermediate brightness and the high brightness.

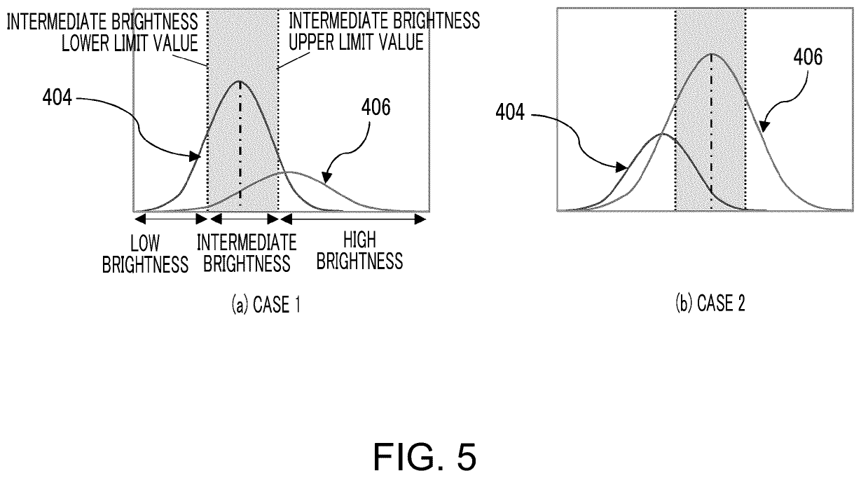

An example of the processing of the classification threshold value calculation 106 will be described with reference to FIG. 5. The example of FIG. 5 is an example of a case where the brightness histogram 20 is approximated with a set of two Gaussian functions and the brightness range is classified into three classes of low brightness, intermediate brightness, and high brightness. Here, for description, it is assumed that a maximum value, an average value, and a standard deviation of the Gaussian function 404 having a peak (that is, a maximum value) on the low-brightness side among the two Gaussian functions are α₁, μ₁, and σ₁, respectively, and a maximum value, an average value, and a standard deviation of the Gaussian function 406 having a peak on the high-brightness side are α₂, μ₂, and σ₂, respectively.

In this example, the relationship between the two Gaussian functions included in the approximate Gaussian function 22 is divided into two cases of a case 1 and a case 2. Then, which case the relationship between the two Gaussian functions corresponds to is determined, and one of the two Gaussian functions used to determine the threshold value is selected. In one example, in a case where a condition A “α₁/α₂>3 and μ₁>30” is satisfied, the case 1 is determined, and in a case other than this, the case 2 is determined. A partial condition of α₁/α₂>3 in the condition A means that the maximum value α₁ of the Gaussian function on the low-brightness side is significantly higher than the maximum value α₂ of the Gaussian function on the high-brightness side. The numerical value of 3 as the comparison target shown in this partial condition is merely an example. In addition, the partial condition of average value μ₁>30 means that the average value μ₁ of the Gaussian function is not too low among the brightnesses of 0 to 255 that are represented by 8 bits. The numerical value of 30 as the comparison target is an example.

For the brightness histogram 20 determined to be the case 1 as a result of the case division, the threshold value of the class classification is determined based on the Gaussian function 404 on the low-brightness side. For example, two threshold values, that is, an intermediate brightness lower limit value and an intermediate brightness upper limit value, are obtained according to Expression 1.

$$\begin{matrix}Expression 1 & \\ \begin{matrix}Intermediate brightness lower limit value = \begin{matrix}{μ}_{1} - \\ {γ}_{low 1} \cdot {σ}_{1}\end{matrix} \\ Intermediate brightness upper limit value = \begin{matrix}{μ}_{1} + \\ {γ}_{high 1} \cdot {σ}_{1}\end{matrix}\end{matrix} \} & Expression 1\end{matrix}$$

Here, γ_{low1} and γ_{high1} are predetermined positive coefficients.

As can be seen from Expression 1, in the case 1, a brightness that is a width γ_{low1σ1} in accordance with the standard deviation σ₁ lower than the average value μ₁ of the Gaussian function 404 on the low-brightness side is set as the intermediate brightness lower limit value. In addition, a brightness that is a width _{high1σ1} in accordance with the standard deviation σ₁ higher than the average value μ₁ is set as the intermediate brightness upper limit value. The class “intermediate brightness” is a range from the intermediate brightness lower limit value to the intermediate brightness upper limit value. A range equal to or less than the intermediate brightness lower limit value is the class “low brightness”, and a range equal to or more than the intermediate brightness upper limit value is the class “high brightness”.

In the case 1, a peak value (that is, a maximum frequency) of the Gaussian function 404 on the low-brightness side is significantly higher than a peak value of the Gaussian function 406 on the high-brightness side. Moreover, the brightness of the peak of the Gaussian function 404 on the low-brightness side is not too low. In such a case, it is considered that a portion near the peak of the Gaussian function 406 on the high-brightness side represents a pixel group of a tissue that causes strong reflection, such as a diaphragm or a blood vessel wall, and a portion near the peak of the Gaussian function 404 on the low-brightness side represents a pixel group having intermediate brightness corresponding to a tissue substance portion, such as a liver or a thyroid, better. Therefore, in a case of viewing the entire frequency distribution of the brightness of the B-mode tomographic image, it is considered that the Gaussian function 404 on the low-brightness side represents the pixel group having the intermediate brightness corresponding to the substance portion of the tissue better. Therefore, in the case 1, the lower limit value and the upper limit value of the intermediate brightness are determined based on the Gaussian function 404 on the low-brightness side.

In addition, for the brightness histogram 20 determined to be the case 2 as a result of the case division, the threshold value of the class classification is determined based on the Gaussian function 406 on the high-brightness side. For example, the intermediate brightness lower limit value and the intermediate brightness upper limit value are obtained according to Expression 2.

$$\begin{matrix}Expression 2 & \\ \begin{matrix}Intermediate brightness lower limit value = \begin{matrix}{μ}_{2} - \\ {γ}_{low 2} \cdot {σ}_{2}\end{matrix} \\ Intermediate brightness upper limit value = \begin{matrix}{μ}_{2} + \\ {γ}_{high 2} \cdot {σ}_{2}\end{matrix}\end{matrix} \} & Expression 2\end{matrix}$$

Here, γ_{low2} and γ_{high2} are predetermined positive coefficients.

As can be seen from Expression 2, in the case 2, a brightness that is a width γ_{low2σ2} in accordance with the standard deviation σ₂ lower than the average value μ₂ of the Gaussian function 406 on the high-brightness side is set as the intermediate brightness lower limit value. In addition, a brightness that is a width _{high2σ2} in accordance with the standard deviation σ₂ higher than the average value μ₂ is set as the intermediate brightness upper limit value. As in the case 1, the class of the low brightness and the class of the intermediate brightness are divided by the intermediate brightness lower limit value, and the class of the intermediate brightness and the class of the high brightness are divided by the intermediate brightness upper limit value.

The brightness distribution of the B-mode tomographic image of the heart, the liver, or the like often corresponds to the case 2.

For example, in a case of a cross section in which the liver is mainly present, most of the B-mode tomographic image is a portion of the liver tissue substance having a certain height of brightness, and a portion having a low brightness representing blood in a thick blood vessel in the substance tissue occupies a certain area. Therefore, the brightness distribution of the portion corresponding to the substance tissue is represented by the Gaussian function 406 having a high peak on the high-brightness side, and the brightness distribution of the portion corresponding to the blood is represented by the Gaussian function 404 having a low peak on the low-brightness side. In this case, it is appropriate to determine the range of the intermediate brightness representing the tissue of interest based on the Gaussian function 406 on the high-brightness side.

In addition, in a case of the heart, a portion having low brightness corresponding to blood in the atrium or the ventricle occupies a large portion of the B-mode tomographic image, and a portion having high brightness corresponding to the tissue such as the atrium or the ventricle is relatively small. In this case, the portion corresponding to the blood is represented by the Gaussian function 404 having a high peak on the low-brightness side, and the portion corresponding to the tissue such as the atrium is represented by the Gaussian function 406 having a low peak on the high-brightness side. In this case, the number of pixels corresponding to the tissue such as the atrium is relatively large. Therefore, there is a small possibility that the height (α₁) of the peak of the Gaussian function 404 on the low-brightness side is significantly higher than the height (α₂) of the peak of the Gaussian function 406 on the high-brightness side (for example, α₁/α₂>3, which is one of the conditions of the case division, is satisfied). In addition, since the brightness of the blood flow portion is low, the brightness of the peak of the Gaussian function 404 on the low-brightness side is likely to be low (for example, it is unlikely to satisfy μ₁>30, which is one of the conditions of the case division). Therefore, the brightness histogram of the B-mode tomographic image 10 of the heart is likely to be classified into the case 2.

In both the heart and the liver, the substance portion of the body tissue of interest in the B-mode tomographic image 10 is more strongly represented by the Gaussian function 406 on the high-brightness side, so that it is suitable to determine the range of the intermediate brightness based on the Gaussian function 406 on the high-brightness side.

Returning to the description of FIG. 3, the processor 1002 executes the segment division 108. The segment division 108 is processing of dividing the B-mode tomographic image 10 into a plurality of segments. The segment is a rectangular region consisting of M×N pixels (M and N are positive integers). A divided image 24 is generated by the segment division 108. The divided image 24 is data representing an image of each segment. For example, the divided image 24 is represented by the B-mode tomographic image 10 and a set of information indicating positions of vertical and horizontal division lines that divide each segment. A method of representing the divided image 24 is not limited thereto.

Next, the processor 1002 executes the class classification 110. In the class classification 110, each segment in the divided image 24 is classified into a class.

In one example, in the class classification processing 100, first, the class classification is performed in units of pixels. That is, the processor 1002 classifies each of pixels of the divided image 24 into three classes of low brightness, intermediate brightness, and high brightness in accordance with the brightness. In this classification, the intermediate brightness lower limit value and the intermediate brightness upper limit value shown as an example above are used as the threshold value that divides the classes. Next, the processor 1002 obtains a class having the largest number of pixels in each segment and sets the class as the class of the segment. The classification result 12 obtained by the class classification 110 is provided to the brightness correction processing 200 (refer to FIG. 2).

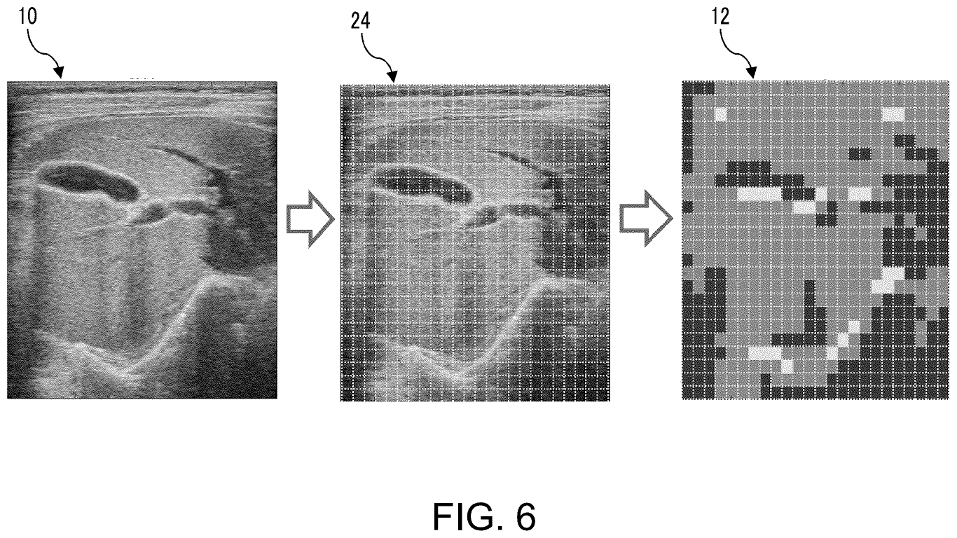

FIG. 6 shows a transition of the data by the segment division 108 and the class classification 110. The B-mode tomographic image 10 is divided into the divided image 24 by the segment division 108. Then, the classification result 12 indicating the class of each segment of the divided image 24 is obtained by the class classification 110.

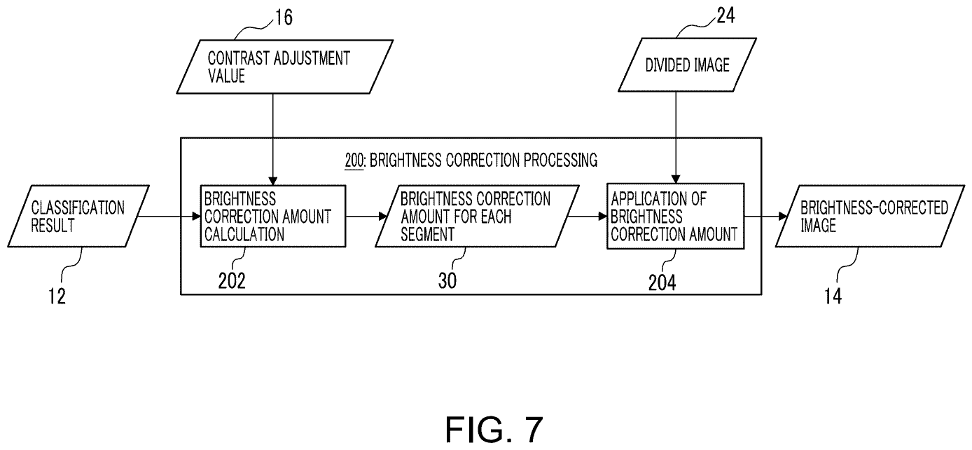

FIG. 7 shows an example of the brightness correction processing 200. In this example, the processor 1002 first performs brightness correction amount calculation 202. In the brightness correction amount calculation 202, the brightness correction amount of each segment is calculated based on the classification result 12. In this calculation, the contrast adjustment value 16 for each class is referred to.

In the brightness correction amount calculation 202, the processor 1002 first calculates a brightness reference value for each class. This calculation is represented by, for example, Expression 3.

$$\begin{matrix}Expression 3 & \\ {μ}_{\_ target ( \# )} = mean ( \# ) + {C}_{( \# )} & Expression 3\end{matrix}$$

Here, # is an identifier of the class. In addition, μ_{target #} is a brightness reference value of the class # and is a value to be obtained in this calculation. The brightness reference value μ_{target #} of the class # is a target value of the average brightness of a segment group corresponding to the class #. In addition, mean(#) is the average brightness of the segment group corresponding to the class # and is obtained based on the classification result 12. That is, since the class of each segment of the B-mode tomographic image 10 is known from the classification result 12, mean(#) is obtained by calculating the average brightness of the pixels of the segment group corresponding to the class #. C_{(#)} is the contrast adjustment value 16 determined in advance for the class #.

In Expression 3, the brightness reference value μ_{target #} for each class is obtained by adding the contrast adjustment value C_{(#)} of the class # to the average brightness mean(#) of the class #. By determining the brightness reference value μ_{target #} for each class in this way, an interval having a magnitude of a difference between the contrast adjustment values of the adjacent classes can be provided between the average brightnesses of the adjacent classes.

Next, the processor 1002 calculates a brightness correction amount 30 for each segment using the brightness reference value μ_{target #} for each class obtained above. The brightness reference value μ_{target #} corresponds to the target brightness corresponding to the class #.

$$\begin{matrix}Expression 4 & \\ \begin{matrix}case , class ( i ) = \# \\ Δ ( i ) = {μ}_{\_ target ( \# )} - mean ( i )\end{matrix} \} & Expression 4\end{matrix}$$

Here, i is an identification number of the segment. In addition, class(i) is a function that returns an identifier # of a class corresponding to i in a case where the identification number i is input, with reference to the classification result 12. Δ(i) is the brightness correction amount of the segment i and is a value to be obtained in this expression. mean(i) is an average of brightness values of pixels in the segment i.

As shown in Expression 4, the brightness correction amount Δ(i) of the segment i is obtained by subtracting the average brightness mean(i) of the segment i from the brightness reference value μ_{target #} of the class # of the segment i. In this way, the brightness correction amount 30 (that is, Δi) for each segment of the B-mode tomographic image 10 is obtained.

Next, the processor 1002 executes the application of a brightness correction amount 204. That is, the processor 1002 adds the brightness correction amount Δi of the segment i to which the pixel belongs to the brightness value of each of pixels of the divided image 24. As a result, the brightness-corrected image 14 is generated.

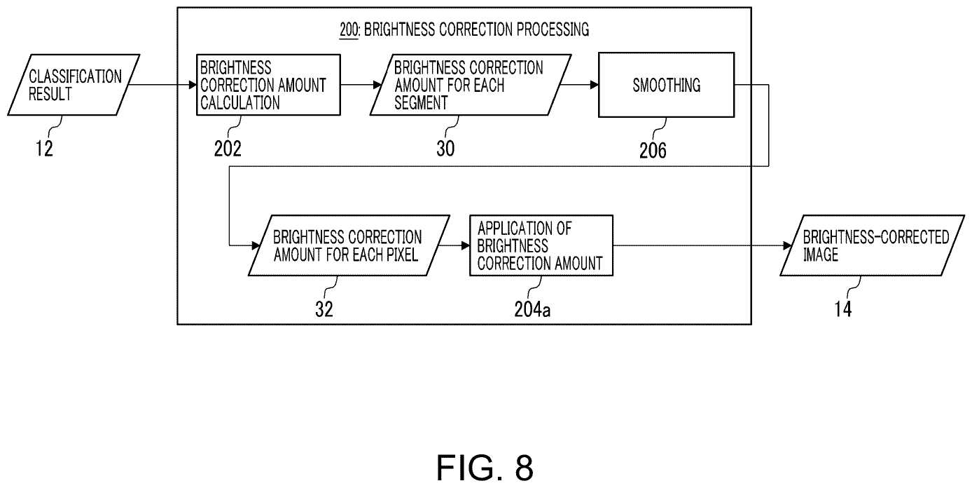

FIG. 8 shows a modification example of the brightness correction processing 200. In FIG. 8, the same reference numerals as those of the processing or data shown in FIG. 7 are assigned to the same processing or data.

In this modification example, the processor 1002 executes smoothing 206 in units of pixels on the brightness correction amount 30 for each segment. The smoothing is performed, for example, by averaging the brightness correction amounts of the pixel and the pixels around the pixel for each pixel to obtain the brightness correction amount of the pixel. A brightness correction amount 32 for each pixel is obtained by the smoothing 206. After the smoothing 206, the processor 1002 adds the brightness correction amount of the pixel among the brightness correction amounts 32 for each pixel to the brightness value of each pixel of the B-mode tomographic image 10. As a result, the brightness-corrected image 14 is generated.

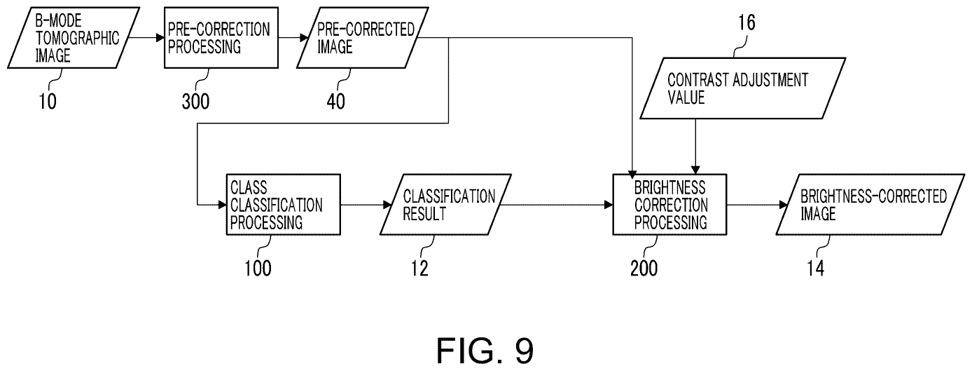

Next, a modification example of the processing of FIG. 2 will be described with reference to FIG. 9. The modification example of FIG. 9 is obtained by adding pre-correction processing 300 to the processing of FIG. 2.

The intensity of the ultrasound is reduced and the brightness is reduced as the position is closer to both ends in the lateral direction of the imaging range, that is, the direction in which the ultrasound beam is scanned, due to the contact failure of the probe or the like. The pre-correction processing 300 includes lateral pre-correction for correcting the reduction in brightness at both end parts in the lateral direction.

In this modification example, the pre-correction processing 300 is performed on the B-mode tomographic image 10 before the correction to generate a pre-corrected image 40. Each of the types of subsequent processing of the pre-correction processing 300, for example, the class classification processing 100 or the brightness correction processing 200 executes the processing on the pre-corrected image 40 instead of the B-mode tomographic image 10. The processing contents of the class classification processing 100 or the brightness correction processing 200 may be the same as those of the embodiment described above.

In the lateral pre-correction, the average brightness at the same depth may be maintained. The lateral pre-correction may be performed, for example, in units of the segments described above. In this case, the segment division of the B-mode tomographic image 10 is performed in the pre-correction processing 300. The class classification processing 100 uses the result of the segment division in the pre-correction processing 300.

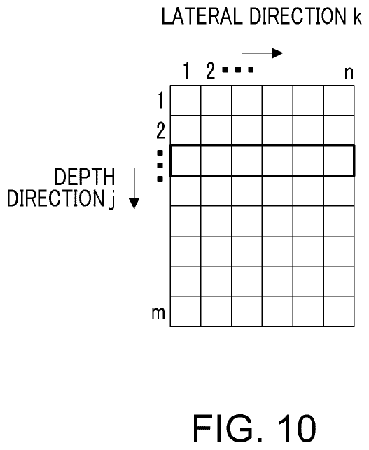

An example of the lateral pre-correction in units of the segments will be described with reference to FIG. 10. FIG. 10 is an example of a case where the B-mode tomographic image 10 is divided into m rows and n columns of the segments, j indicates the number of the segment along the depth direction, and k indicates the number of the segment along the lateral direction. Therefore, the segment jk is a segment of the j-th row and the k-th column.

In this example, the processor 1002 calculates a brightness difference g_{0_jk} of the segment jk according to, for example, Expression 5 described below.

$$\begin{matrix}Expression 5 & \\ {g}_{0 \_ jk} = {μ}_{\_ jk} - {μ}_{\_ whole} & Expression 5\end{matrix}$$

Here, μ_jk is an average brightness of the pixels in the segment jk, and μ_whole is an average brightness of the pixels in the entire B-mode tomographic image 10.

Next, the processor 1002 calculates a brightness correction amount g_{1_jk} of the segment jk for the lateral direction correction according to, for example, Expression 6 described below.

$$\begin{matrix}Expression 6 & \\ {g}_{1 \_ jk} = {g}_{0 \_ jk} - ( {g}_{0 \_ j 1} + {g}_{0 \_ j 2} + {g}_{0 \_ j 3} + … + {g}_{0 \_ jn} ) / n & Expression 6\end{matrix}$$

Expression 6 indicates that the brightness correction amount g_{1_jk} is obtained by subtracting an average of brightness differences g_{0_j1}, g_{0_j2}, g_{0_j3}, . . . , and g_{0_jn} of the segments j1, j2, j3, . . . , and jn at the same depth j from the brightness difference g_{0_jk} of the segment jk.

In the lateral pre-correction, the processor 1002 subtracts the brightness correction amount g_{1_jk} obtained according to Expression 6 from the brightness for each of pixels in the segment jk. According to this correction calculation, the brightness reduced at both end parts in the lateral direction can be increased without changing the average brightness at the same depth j before and after the correction.

The example of the lateral pre-correction has been described above.

In addition to the reduction in brightness at both end parts in the lateral direction dealt with by the lateral pre-correction, the ultrasound image has a feature that the brightness is reduced as the depth increases. The reduction in brightness in the depth direction may be corrected by the TGC known in the related art. For example, the pre-correction processing 300 may perform the TGC as the depth direction pre-correction on the B-mode tomographic image 10 before the TGC is applied, which is input. In this case, the depth direction pre-correction and the lateral pre-correction may be executed in any order. Further, as another example, the pre-correction processing 300 may receive the B-mode tomographic image 10 on which the TGC has been applied as the input and perform the lateral pre-correction on the B-mode tomographic image 10.

In addition, an upper limit value may be set for the magnitude of the brightness correction amount of the depth direction pre-correction and the lateral pre-correction, and the magnitude of the calculated brightness correction amount may not exceed the upper limit value. As a result, the possibility of excessive correction can be reduced.

In addition, in this case, the upper limit value of the magnitude of the brightness correction amount of the lateral pre-correction may be set to a value larger than the upper limit value of the brightness correction amount of the depth direction pre-correction. Since the reduction in brightness at the end part in the lateral direction is larger than the reduction in brightness due to the attenuation in the depth direction, the large reduction in brightness at the end part in the lateral direction can be corrected by setting the upper limit value of the lateral pre-correction to a large value.

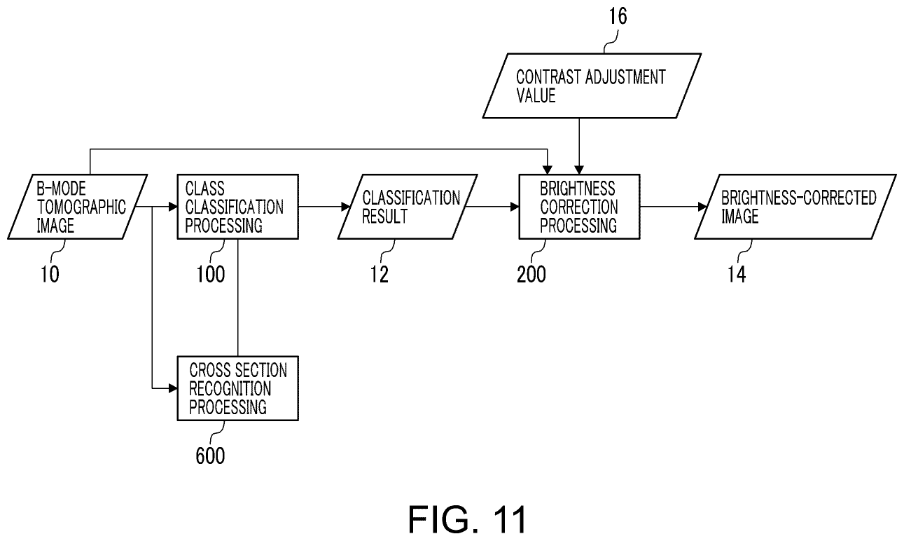

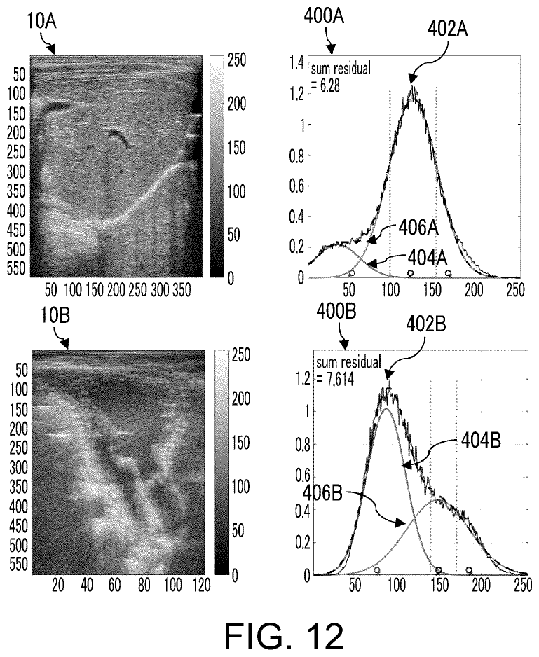

Next, a further modification example will be described with reference to FIGS. 11 and 12. FIG. 11 shows processing executed by the processor 1002 in this modification example. In FIG. 11, the same reference numerals as those of the processing or data shown in FIG. 2 are assigned.

As shown in FIG. 11, in this modification example, the processor 1002 executes cross section recognition processing 600 on the B-mode tomographic image 10, and the cross section recognition result obtained by this processing is used in the class classification processing 100.

The cross section recognition processing 600 is processing of recognizing which cross section of the subject is represented by the ultrasound image (in this example, the B-mode tomographic image 10). The cross section of the subject is specified by, for example, a combination of an organ such as an organ in the subject and a positional relationship between the cross section and the organ. In addition, in a guideline for ultrasound diagnosis for each part such as a heart, an abdomen, and a breast, a cross section to be imaged in the diagnosis of the part is determined.

The cross section recognition processing 600 is realized by, for example, a machine learning model. The machine learning model is constructed by, for example, a method such as a neural network. In order to construct the machine learning model, for example, a large number of pairs of the ultrasound image and information (for example, an identification name of the cross section) for specifying the cross section indicated by the ultrasound image are prepared as training data. Then, the machine learning model is trained by inputting the ultrasound image as input data and the information for specifying the cross section as labeled data to the machine learning model. The machine learning model sufficiently trained in this way is used for the cross section recognition processing 600. In a case where the ultrasound image is input, the trained machine learning model determines the cross section indicated by the image and outputs information for specifying the determined cross section as the cross section recognition result. The class classification processing 100 is controlled based on the cross section recognition result. Since there is a specific tendency in the frequency distribution of the brightness in the B-mode tomographic image for each organ, the class classification processing 100 performs processing in accordance with the tendency according to the type of the organ indicated by the cross section recognition result.

For example, the type of the distribution function used in the multi-distribution function analysis 104 may be determined in accordance with the cross section recognition result. In addition, the number of distribution functions used in the multi-distribution function analysis 104 may be determined in accordance with the cross section recognition result.

As another example, the calculation condition of the upper limit value and the lower limit value of the intermediate brightness may be determined in accordance with the cross section recognition result. Examples of the calculation condition include coefficients γ_{low1}, γ_{high1}, γ_{low2}, and γ_{high2} in Expression 1 and Expression 2 described above.

For example, FIG. 12 shows an example of a B-mode tomographic image 10A of a liver and an analysis result 400A of a brightness distribution of the liver and a B-mode tomographic image 10B of a heart and an analysis result 400B of a brightness distribution of the heart.

In the analysis result 400A of the liver, a brightness histogram 402A is approximated by a set of two Gaussian functions 404A and 406A. In a case of the liver, the peak of the Gaussian function 406A on the high-brightness side is higher, and it is considered that the Gaussian function 406A corresponds to the substance portion of the liver tissue.

On the other hand, in the analysis result 400B of the heart, the peak of the Gaussian function 404B on the low-brightness side is higher in the two Gaussian functions 404B and 406A that approximate a brightness histogram 402B, but the Gaussian function 406B on the high-brightness side corresponds to the portion of the heart tissue.

Since the area of the substance portion of the B-mode tomographic image 10B of the heart is smaller than that of the liver, the ratio of the intermediate brightness is small. Therefore, the coefficients γ_{low} and γ_{high} in Expression 1 and Expression 2 are set to a smaller value in a case of the heart than in a case of the liver.

The modification example of using the cross section recognition result has been described above. It is also possible to apply the pre-correction processing 300 described with reference to FIGS. 9 and 10 to the method of this modification example.

In the example described above, the brightness range is classified into three classes of low brightness, intermediate brightness, and high brightness, but this is merely an example. The method shown in the present disclosure can be applied to a case where the brightness range is classified into two classes and a case where the brightness range is classified into four or more classes.

In the present embodiment, each processing is executed by any computer. In addition, any computer may execute these types of processing by a processor as hardware, a program as software, or a combination thereof. In such a case, the processor is configured to execute various types of processing in the present embodiment in cooperation with the program, and may function as each unit or each means in the present embodiment. In addition, the execution order of the processing by the processor is not limited to the above-described order and may be changed as appropriate. Any computer may be a general-purpose computer, a computer for specific use, a workstation, or another system that can execute each processing.

The processor may be configured by one or more kinds of hardware, and the type of hardware is not limited. For example, the processor may be configured by a programmable logic device such as a central processing unit (CPU), a micro processing unit (MPU), or a field programmable gate array (FPGA), a dedicated circuit for executing specific processing, such as an application-specific integrated circuit (ASIC), or hardware such as a graphic processing unit (GPU) or a neural processing unit (NPU). Moreover, the type of hardware may be a combination of different kinds of hardware. In a case where the plurality of types of hardware are configured to execute one or a plurality of types of processing of a certain processor, the plurality of types of hardware may exist in devices physically separated from each other or may exist in the same device. Furthermore, in any of the embodiments, the order of each processing performed by the processor is not limited to the above-described order, and may be changed as appropriate. In addition, hardware is implemented in a form of an electric circuit (circuitry) in which circuit elements, such as semiconductor elements, are combined.

Furthermore, the program may be software such as firmware or a microcode. The program may be, for example, a group of program modules, and each function thereof may be implemented by a processor configured to execute each function. The program may be a program code or a plurality of code segments stored in one or more non-transitory computer-readable media (for example, a storage medium and other storages). The program may be stored in the plurality of non-transitory computer-readable media present in devices physically separated from each other. The program code or the code segment may represent any combination of procedures, functions, subprograms, routines, subroutines, modules, software packages, classes, instructions, data structures, or program statements. The program code or the code segment may be connected to another code segment or a hardware circuit by transmitting and receiving information, data, arguments, parameters, or contents in the memory.

What is claimed is:

1. An ultrasound image processing apparatus comprising: a processor,
wherein the processor is configured to:
approximate a brightness histogram of a correction target ultrasound image using a combination of a plurality of distribution functions;
determine one or more threshold values for a brightness based on at least one of the plurality of distribution functions;
divide the correction target ultrasound image into a plurality of regions;
classify the plurality of regions into a plurality of classes based on the one or more threshold values; and
execute, for each of the plurality of regions, brightness correction for each of pixels in the region in accordance with a target brightness corresponding to the class to which the region belongs.

2. The ultrasound image processing apparatus according to claim 1,
wherein the processor is configured to:
select one distribution function from among the plurality of distribution functions; and
determine the one or more threshold values based on the selected distribution function.

3. The ultrasound image processing apparatus according to claim 2,
wherein the plurality of distribution functions are two distribution functions, and
the processor is configured to select, in the selection, a distribution function on a low-brightness side of the two distribution functions, in a case where a height at a peak of the distribution function on the low-brightness side of the two distribution functions is equal to or higher than a predetermined number of times a height at a peak of a distribution function on a high-brightness side of the two distribution functions and a brightness corresponding to the peak of the distribution function on the low-brightness side is equal to or more than a predetermined value.

4. The ultrasound image processing apparatus according to claim 1,
wherein the processor is configured to correct, as the brightness correction, a brightness for each of the pixels such that an average brightness is equal among regions belonging to the same class.

5. The ultrasound image processing apparatus according to claim 1,
wherein intervals each having a predetermined magnitude or greater are provided between the respective target brightnesses of adjacent classes.

6. The ultrasound image processing apparatus according to claim 1,
wherein the processor is configured to:
execute pre-correction on an ultrasound image before the correction; and
handle the ultrasound image subjected to the pre-correction as the correction target ultrasound image, and
the pre-correction includes lateral pre-correction of increasing the brightness as a position is closer to an end part in a lateral direction for the ultrasound image before the correction.

7. The ultrasound image processing apparatus according to claim 6,
wherein the pre-correction further includes depth direction pre-correction of increasing the brightness as a depth increases in a depth direction for the ultrasound image before the correction, and
an upper limit value of an amount of increase in the brightness due to the lateral pre-correction is larger than an upper limit value of an amount of increase in the brightness due to the depth direction pre-correction.

8. The ultrasound image processing apparatus according to claim 1,
wherein the processor is configured to determine, based on a recognition result of a cross section represented by the ultrasound image, at least one of a type of a distribution function used as the plurality of distribution functions or the number of distribution functions constituting the combination of the plurality of distribution functions.

9. The ultrasound image processing apparatus according to claim 1,
wherein the processor is configured to:
determine a calculation condition of the one or more threshold values based on a recognition result of a cross section represented by the ultrasound image; and
determine the one or more threshold values according to the calculation condition.

10. A non-transitory computer readable medium storing a program for causing a computer to execute a process comprising:
approximating a brightness histogram of a correction target ultrasound image using a combination of a plurality of distribution functions;
determining one or more threshold values for a brightness based on at least one of the plurality of distribution functions;
dividing the correction target ultrasound image into a plurality of regions;
classifying the plurality of regions into a plurality of classes based on the one or more threshold values; and
executing, for each of the plurality of regions, brightness correction for each of pixels in the region in accordance with a target brightness corresponding to the class to which the region belongs.

11. A method for brightness correction comprising:
approximating a brightness histogram of a correction target ultrasound image using a combination of a plurality of distribution functions;
determining one or more threshold values for a brightness based on at least one of the plurality of distribution functions;
dividing the correction target ultrasound image into a plurality of regions;
classifying the plurality of regions into a plurality of classes based on the one or more threshold values; and
executing, for each of the plurality of regions, brightness correction for each of pixels in the region in accordance with a target brightness corresponding to the class to which the region belongs.
